(19) United States
(12) Patent Application Publication
(10) Pub. No.: US 2024/0060247 A1
(43) Pub. Date: Feb. 22, 2024

(54) GROUND STRUCTURE AND CONSTRUCTION METHOD THEREOF

(71) Applicant: Tokuyama Corporation, Tsukuba-shi (JP)

(72) Inventors: Tatsuo SHINMI, Shunan-shi (JP); Hiroyoshi KATO, Shunan-shi (JP); Yoshinobu TSUKUDA, Tokyo (JP); Takaaki KURODA, Tokyo (JP)

(21) Appl. No.: 18/235,958

(22) Filed: Aug. 21, 2023

(30) Foreign Application Priority Data
Aug. 22, 2022 (JP) 2022-131756

(51) Int. Cl. E01C 13/02; C04B 28/02; C04B 14/06; C04B 18/10; C04B 18/14; E01C 13/08

(52) U.S. Cl. CPC E01C 13/02; C04B 28/02; C04B 14/06; C04B 18/103; C04B 18/141; E01C 13/08

(57) ABSTRACT

A ground structure comprises a basis comprising arranged concrete blocks and an artificial turf fixed to the basis. The concrete blocks contain cement, sand, and an inorganic water retaining material, and have a water permeability of not less than 1.0×10⁻⁴ m/s and not more than 10.0×10⁻⁴ m/s and a water retention capacity of not less than 0.10 g/cm³ and not more than 0.40 g/cm³, both measured in accordance with JIS A 5371. The artificial turf comprises a base sheet made of synthetic resin having drain holes and a synthetic resin pile fixed to the base sheet.

### FIELD OF THE INVENTION

The invention relates to a ground structure that comprises an artificial turf and a basis suitable for grounds in schools, playgrounds, etc. and a method for constructing the same. In detail, the invention relates to the ground structure that has the basis comprises or consists of concrete blocks with a water permeability of 1.0×10⁻⁴ m/s or higher and a water retention capacity of 0.10 g/cm³ or higher and to reduce thereby the temperature increases due to solar radiation during summer.

### BACKGROUND ART

Soil pavements using sand or soil have been used for grounds in schools and playgrounds because they are low-cost and easy to construct. However, for avoiding dust and dirt, school grounds or the like have been converted to turf grounds. In such cases, artificial turf has been often used to reduce the construction and maintenance costs.

Ground structures containing artificial turf comprise generally a basis comprising or consisting of concrete pavement, asphalt pavement, or soil pavement, artificial turf, and ancillary texture sand. The artificial turf is fixed onto the basis with joint tape or adhesive. After fixing the artificial turf onto the basis, the texture sand is spread by a sand spreader and filled by a brush.

However, when exposed to strong sunlight in summer, artificial turf becomes hotter than natural turf and soil. This is because artificial turf is manufactured with synthetic resin and tends to absorb sunbeam heat.

### Prior Non-Patent Document

Kentaro Iijima: “Sports Injuries Caused by Ground Surfaces, and Artificial and Natural Turf”, J. Jpn. Soc., Turfgrass Science, 42 (1), 1-8, October 2013.

Concrete, asphalt, and soil pavements of the bases of the ground structures have low water retention properties, so they do not retain enough water when water is sprinkled, and the temperature drop according to the vaporization heat is small.

During summer seasons, direct contact between human bodies and artificial turf may cause burns. Therefore, a method to reduce the surface temperature of artificial turf has been sought.

The object of the invention is to provide a ground structure and its construction method that reduce the rise in the surface temperature of artificial turf due to solar radiation.

The present inventors have conducted research to achieve the above object. The present inventors have found that the temperature rise due to solar radiation can be reduced by concrete blocks that have high water permeability and water retention properties and are suitable for the basis of the structure comprising or consisting of artificial turf and the basis and have completed the present invention after further study.

The ground structure according to the present invention comprises a basis comprising or consisting of arranged concrete blocks and an artificial turf fixed to the basis. The concrete blocks contain cement, sand, and an inorganic water retaining material, and have a water permeability of not less than 1.0×10⁻⁴ m/s and not more than 10.0×10⁻⁴ m/s and a water retention capacity of not less than 0.10 g/cm³ and not more than 0.40 g/cm³, both measured in accordance with JIS A 5371. The water retention capacity and the water permeability are nearly determined by the species and the content of the water retaining material. The artificial turf comprises a base sheet made of synthetic resin having drain holes and a synthetic resin pile fixed to the base sheet. The ground structure is used with texture sand sprinkled on the artificial turf.

According to the construction method of the ground structure of the invention, a mixture of cement, sand, an inorganic water retaining material, and water is prepared. Then, the mixture is molded in a mold having a shape of the concrete block and cured to produce the concrete blocks. The produced concrete blocks have a water permeability of not less than 1.0×10⁻⁴ m/s and not more than 10.0×10⁻⁴ m/s and a water retention capacity of not less than 0.10 g/cm³ and not more than 0.40 g/cm³, both measured in accordance with JIS A 5371. The produced concrete blocks are arranged in a matrix on ground, and the artificial turf that comprises a base sheet of synthetic resin having drain hoes and a pile of synthetic resin fixed to the base sheet is fixed on the arranged concrete blocks. Then, the texture sand is sprinkled on the artificial turf. The descriptions of the ground structure in this specification also apply to the method of its implementation unless otherwise specified.

According to the present invention, the temperature rise of the artificial turf surface due to solar radiation is reduced by the concrete blocks having the appropriate water permeability and the appropriate water retention capacity.

Preferably, the concrete blocks have a water permeability of not less than 2.0×10⁻⁴ m/s and not more than 7.0×10⁻⁴ m/s and a water retention capacity of not less than 0.15 g/cm³ and not more than 0.30 g/cm³ or less.

Preferably, the inorganic water retaining material comprises or consists of at least one of ceramic solidified material which is a sintered sludge and a water-granulated slag produced by water-granulating high-temperature slag from a metal refining furnace as a by-product. The ceramic solidified material is for example produced from a wasted material from sewage, and the water-granulated slag is a by-product from blast furnaces and so on. When the ceramic solidified material or the granulated slag is fixed in the concrete blocks, the waste or by-product is safely disposed of. In addition, the ceramic solidified material and the granulated slag are inexpensive water retaining materials with excellent water permeability and water retention capacity.

Preferably, the concrete blocks contain cement of not less than 350 kg and not more than 450 kg, sand of not less than 600 kg and not more than 1500 kg, the inorganic water retaining material of not less than 500 kg and not more than 1500 kg, and coarse aggregate of at least 0 kg and not more than 200 kg, in each volume of 1 m³ of the concrete blocks. Coarse aggregate is, for example, crushed stone or gravel from rivers, hills, etc. The coarse aggregate has preferably an average grain size of at least 2 mm and at most 25 mm. The sand is, for example, crushed sand made by crushing stones and so on collected from mountains, hills, etc. and separating to the stones and sand. However, sand collected from the sea, rivers, etc. may also be used.

### BRIEF DESCRIPTION OF THE DRAWINGS

FIG. 1 A cross-sectional view of the ground structure according to the embodiment.

FIG. 2 An enlarged cross-sectional view of the ground structure in FIG. 1.

FIG. 3 A plan view of the concrete block used in the embodiment.

FIG. 4 A perspective view of the concrete block used in the embodiment.

FIG. 5 A process chart of the ground construction method according to the embodiment.

The artificial turf used in the invention comprises or consists of a base sheet of polyethylene, polypropylene, nylon, or the like and a pile of polypropylene or the like fixed to the base sheet. Artificial turfs satisfying these conditions can be used without restrictions. In addition, to make it easier for water to reach and evaporate from the concrete blocks, the base sheet preferably has drain holes, or drain holes may be drilled into the base sheet to a suitable degree.

The most significant feature of the present invention is that concrete blocks with a water permeability of 1.0×10⁻⁴ m/s or higher and a water retention capacity of 0.10 g/cm³ or higher are used for the basis of the structure comprising or consisting of artificial turf and the basis. If the water permeability is less than 1.0×10⁻⁴ m/s, water will not permeate the basis and flow over the surface of the artificial turf to the outside when water is sprinkled. If the water permeability is too large, the pore volume in the concrete blocks will increase with a result of a decrease in strength, so a water permeability of not more than 10.0×10⁻⁴ m/s is preferred. If the water retention capacity is less than 0.10 g/cm³, the vaporization heat is not sufficient to cool the artificial turf. If the water retention capacity is too large, the pore volume in the concrete blocks will increase, leading to a decrease in strength, so the water retention capacity is preferably not more than 0.40 g/cm³. More preferably, the water permeability is not less than 2.0×10⁻⁴ m/s and not more than 7.0×10⁻⁴ m/s, and the water retention capacity is not less than 0.15 g/cm³ and not more than 0.30 g/cm³. The water permeability and water retention capacity are measured according to the method described in JIS A 5371 “Precast unreinforced concrete products.”

According to the present invention, at least a water retaining material is mixed into the concrete blocks to ensure the specified water retention capacity and water permeability. For example, ceramic solidified material made by sintering sewage sludge at 1000° C. or the like can be used as the water retaining material. granulated blast furnace slag, which is generally used as a water retaining pavement material, is also preferred. Granulated blast furnace slag is obtained by spraying water, quenching by the water, and thereby granulating hot slag from blast furnaces into a sand-like form. Both ceramic solidified material and granulated blast furnace slag have excellent water permeability and water retention performance. However, since granulated blast furnace slag has a high fines content, its water permeability tends not to increase significantly when a large amount of it is added.

These materials are porous, hold a large amount of water in their pore, and are water permeable. Although they are porous, they have a certain degree of strength, and therefore they rarely cause a decrease in strength when a large amount of them is added to the concrete blocks.

The inorganic water retaining material used according to the present invention has preferably a 5.0 mm sieve residue of less than 5% and a 0.075 mm sieve pass rate of less than 5% in the particle size range.

The concrete blocks that have the above water permeability and water retention capacity can be used without restrictions. The concrete blocks are preferably those that have been produced by filling raw concrete in a mold of a predetermined shape, vibrating or otherwise tightening, and then immediately de-molding. They may be produced by filling raw concrete in the same way, curing them statically in the mold, and de-molding them after curing.

Regarding the concrete blocks for the basis, the cement as a raw material can be any known cement such as JIS R 5210 “Portland cement”, JIS R 5211 “Blast furnace cement”, JIS R 5212 “Silica cement”, JIS R 5213 “Fly ash cement”, JIS R 5214 “Eco cement”, JIS R 5214 “Eco cement,” etc.

In addition, known inorganic powders can be mixed as long as the strength of the concrete blocks is satisfied. Inorganic powders as those small content components specified by JIS R 5210 “Portland cement”, “Fly ash for concrete” specified by JIS A 6201, “Silica fume for concrete” specified by JIS A 6207, limestone fine powder, etc. are usable.

For producing the concrete blocks for the basis according to the present invention, aggregates (fine aggregate and coarse aggregate) are used without restrictions. For example, natural aggregates such as crushed stone and sand, slag aggregates defined in JIS A 5011, light-weight aggregates, water retaining materials, and so on can be used without restrictions.

Water usable for the production of concrete blocks is one for the preparation of mortar and concrete blocks without restrictions. Industrial water and tap water are, for example, preferable.

When producing the concrete blocks used in the invention for the basis, in addition to the above aggregate, cement, and water, additives for mortar and concrete preparation such as AE water reducing agent, high-range AE water reducing agent, high-range AE water reducing agent, air-entraining agent, and setting accelerators may also be mixed as long as they do not interfere with the advantageous effects of the present invention.

According to the present invention, the concrete blocks have preferably a water/cement ratio of not less than 23% and not more than 35% and a unit water content of not less than 110 kg/m³ and not more than 130 kg/m³.

When ceramic solidified material is used as the water retaining material according to the present invention, the amount of ceramic solidified material is not less than 150 kg and not more than 400 kg per 1 m³ of concrete. When the ceramic solidified material is used as the fine aggregate, the fine aggregate ratio is not less than 80% and up to 100%.

When granulated blast furnace slag is used as the water retaining material according to the present invention, the amount of granulated blast furnace slag is not less than 500 kg and not more than 1700 kg per 1 m³ of concrete. When granulated blast furnace slag is used as fine aggregate, the fine aggregate ratio is not less than 80% and up to 100%.

When both ceramic solidified material and granulated blast furnace slag are used as the water retaining materials according to the present invention, the amount of the ceramic solidified material is not less than 150 kg and not more than 250 kg per 1 m³ of concrete, and the amount of granulated blast furnace slag is not less than 400 kg and not more than 800 kg per 1 m³ of concrete. When both ceramic solidified material and granulated blast furnace slag are used, the fine aggregate ratio (weight ratio of fine aggregate in aggregate) is not less than 80% and up to 100%.

The concrete blocks used for the basis of the invention have preferably a flexural strength of 5 N/mm² or more when vehicles will pass over, and 3 N/mm² or more when they will not pass over.

When producing the concrete blocks, aggregate, cement, water, and additional other materials, if needed, are mixed and cured. General production methods for concrete blocks used in ready-mixed concrete products and secondary concrete products are usable without restrictions.

General mixers for mixing mortar and concrete are usable for mixing aggregate, cement, water, and other materials without restrictions. Specifically, pan-type mixers, forced twin-shaft mixers, tilting mixers, mortar mixers, hand mixers, and so on can be used.

The cure of the concrete blocks can be performed by conventional curing methods in ready-mixed concrete plants and secondary concrete product plants without restrictions. In particular, wet curing, underwater curing, steam curing, autoclave curing, air curing, and so on are usable.

The arrangement of the concrete blocks can be performed according to a general arrangement method of interlocking blocks and so on without restrictions. For example, the concrete blocks are arranged on the ground after treating it, and the gaps between the concrete blocks are filled with sand, if necessary.

General methods for paving artificial turf on asphalt or concrete can be used for paving the artificial turf on the concrete blocks according to the invention without restrictions. For example, dirt and dust are removed from the top surface of the concrete blocks, adhesive is applied to the top surface of the concrete blocks, and the artificial turf is fixed. The artificial turf may be fixed on the concrete blocks with an adhesive tape. On the paved artificial turf, texture sand is sprinkled. The texture sand is hill sand, sea sand, river sand, and so on, for example.

The maximum grain size of the texture sand is 4 mm or less, and preferably 2 mm or less. The amount of the texture sand is such that the texture sand on the artificial turf is 5 mm or less, and preferably 1 to 3 mm in thickness. For applying the texture sand, general methods for spreading sand over artificial turf can be used without restrictions. For example, the texture sand is spread evenly by hand or with a spreader, and then the texture sand is evened with a ground rake or similar tool. Then, the texture sand is rubbed in with a deck brush, etc., and water is sprinkled on the artificial turf.

### Embodiment

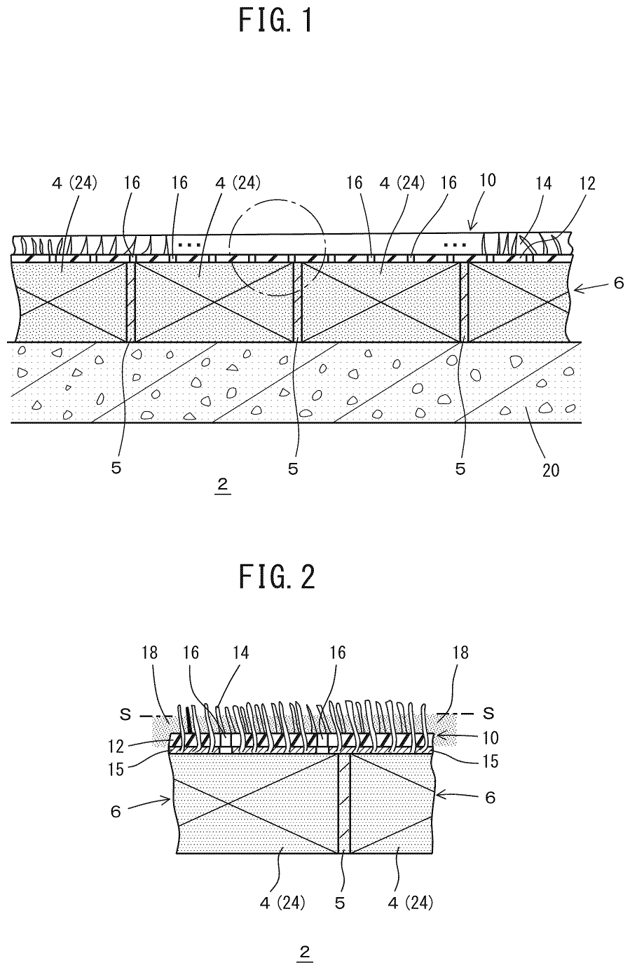

FIGS. 1 to 5 indicate the embodiment. The invention is not limited to the embodiment. In addition, some of the features described in the embodiment are not essential.

FIGS. 1 and 2 indicate the ground structure 2 according to the embodiment. The ground structure 2 is constructed on ground 20 of soil or the like after adding appropriate treatment to the ground, if needed. The ground structure 2 comprises or consists a basis 6 consisting of concrete blocks 4, 24 arranged in a matrix on the ground 20 and at least an artificial turf 10 fixed onto the basis 6. The gaps 5 between the concrete blocks 4, 24 are filled with sand, for example.

The artificial turf 10 is made of, for example, a synthetic resin base sheet 12 to which is fixed a pile 14 of polypropylene or other synthetic resin that folds back in a U-shape at the lower end. The base sheet 12 is equipped with drain holes 16 to permeate sprinkled water and precipitation to the concrete blocks 4, 24 and to allow the vapor evaporated from the concrete blocks 4, 24 to pass through. The adhesive layer 15 on the back of the artificial turf 10 fixes the artificial turf 10 to the basis 6. It may also be fixed by an adhesive tape or other means. The pile 14 of the artificial turf 10 is filled with a layer of texture sand 18. The chain line S in FIG. 2 indicates the height of the sand filling.

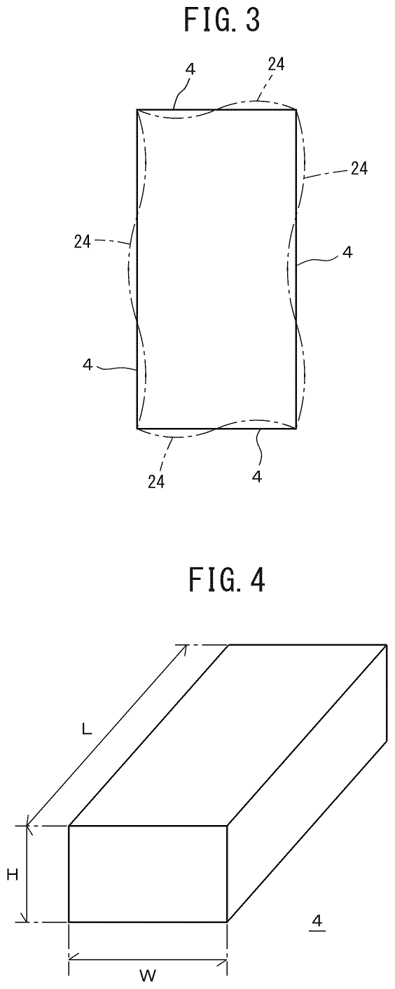

FIGS. 3 and 4 show the concrete blocks 4, 24. The size is, for example, 100 mm in width W, 60 mm in height H, and 200 mm in length L. The rectangular concrete blocks 4 and the concrete blocks 24 with irregularities on the four sides (indicated by the chain line in FIG. 3) are both usable.

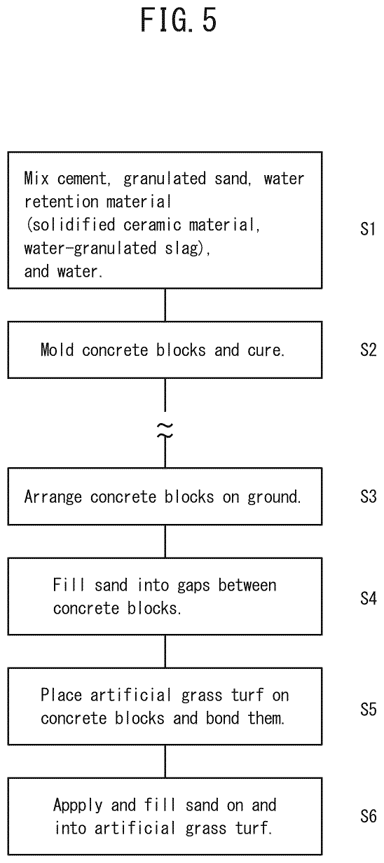

FIG. 5 shows the construction method of the ground structure. Cement, such as Portland cement, crushed sand, and water retaining material are mixed with water (Step 1). The water retaining material is, for example, ceramic solidified material and/or water-granulated blast furnace slag. The above mixture is filled into and formed in a mold and cured to produce concrete blocks 4, 24 (Step 2).

The concrete blocks 4, 24 are arranged on the ground 20 (step 3), and the gap 5 between the concrete blocks 4, 24 is filled with sand (step 4) to form the basis 6. Then, the artificial turf 10 is placed on the basis 6 and fixed by an adhesive layer 15 (step 5). Texture sand is then spread on top of the artificial turf 10 (Step 6) to complete the ground structure 2. The ground structure 2 can supply water to the concrete blocks 4, 24 by sprinkling water, etc. The large porosity of the water retaining material allows it to store a large amount of water, and the high water permeability of the water retaining material allows the sprinkled water to be quickly absorbed in the concrete blocks 4, 24.

### Experimental Examples

Table 1 shows the compositions of concrete blocks 4 used in the experiments (comparative examples and embodiments 1-3). The percentages represent weight percentages. The construction method from the production of the concrete blocks 4, 24 to the fixing of the artificial turf 10 and the spreading of the texture sand has already been described.

TABLE 1

| | Water/ | Fine | Composition (Kg/m³) | | | | | |
|---|---|---|---|---|---|---|---|---|
| | Cement | Aggregate | | | | Water | | |
| | Ratio | Ratio | | | | Retaining Material | | Coarse |
| | (%) | (%) | Water | Cement | Gravel | Ceramic | Slag | Aggregate |
| Com. 1 | 28 | 62 | 120 | 429 | 1250 | 0 | 0 | 760 |
| Emb. 1 | 30 | 100 | 120 | 400 | 831 | 230 | 650 | 0 |
| Emb. 2 | 29 | 96 | 115 | 400 | 1350 | 0 | 650 | 73 |
| Emb. 3 | 30 | 100 | 120 | 400 | 624 | 9 | 1455 | 0 |

The test method is as follows.

### Surface Temperature Measurement Under Solar Radiation

Two concrete blocks of 100 mm wide, 200 mm long, and 60 mm high were immersed in water at 20 degree Celsius for 24 hours to make them retain water. The concrete blocks after water immersion were placed on a dry concrete slab and surrounded by a styrofoam board. A commercially available artificial turf (“artificial turf roll-wrapped real type”, sold by CAINZ) consisting of a polypropylene pile and a polyethylene base sheet was placed on top of the blocks, and hill sand (fineness modulus: 1.21, water retention rate: 0.90%) was spread over the artificial turf as texture sand to construct ground structures. The fineness modulus is a customarily used value to indicate the coarseness/fineness of sand or the like. The water retention rate of 1% indicates that a material such as sand of dry weight of 100 g retains 1 g of water when the surface of the material is dry but the interior of it is wet. After sprinkling 500 ml of 20 degree Celsius water from the top surface of the prepared ground structure, heating was immediately started with a 250 W infrared lamp from a height of 30 cm from the artificial turf surface, and the surface temperature in the center of the artificial turf was measured using thermocouples.

### Comparative Example 1

Interlocking blocks 24 (Standard interlocking blocks of Tokuyama Trading) having the composition of Com. 1 in Table 1 with a water permeability of 0 m/s and a water retention capacity of 0.07 g/cm³, both measured according to JIS A 5371, were used for the basis 6. Using the interlocking blocks 24, the artificial turf, and the texture sand, the ground structure according to Comparative example 1 was prepared. The surface temperature of the artificial turf was 70 degree Celsius under the radiation of 60 minutes.

### Embodiment 1

Interlocking blocks 24 having the composition of Emb. 1 in Table 1, with a water permeability of 5.0×10⁻⁴ m/s and a water retention capacity of 0.21 g/cm³, both measured according to JIS A 5371, were used for the basis 6. The ground structure according to the embodiment 1 consisted of the interlocking blocks 24, the artificial turf, and the texture sand. The water retaining materials in the interlocking blocks 24 were ceramic solidified material made by sintering sewage effluent sludge at 1000 degree Celsius and granulated blast furnace slag. The surface temperature of the artificial turf of the ground structure was 59 degree Celsius under the radiation of 60 minutes.

### Embodiment 2

Interlocking blocks 24 having the composition of Emb. 2 in Table 1, with a water permeability of 4.6×10⁻⁴ m/s and a water retention capacity of 0.21 g/cm³, both measured according to JIS A 5371, were used for the basis 6. The ground structure according to the embodiment 2 consisted of the interlocking blocks 24, the artificial turf, and the texture sand. The water retaining material in the interlocking blocks 24 was granulated blast furnace slag. The surface temperature of the artificial turf was 57 degree Celsius under the radiation of 60 minutes.

### Embodiment 3

Interlocking blocks 24 having the composition of Emb. 3 in Table 1, with a water permeability of 3.1×10⁻⁴ m/s and a water retention capacity of 0.20 g/cm³, both measured according to JIS A 5371, were used for the basis 6. The ground structure according to the embodiment 3 consisted of the interlocking blocks 24, the artificial turf, and the texture sand. The water retaining materials in the interlocking blocks 24 were mainly granulated blast furnace slag. The surface temperature of the artificial turf surface was 57 degree Celsius under the radiation of 60 minutes.

TABLE 2

| | water | water retention | Surface Temp. of |
|---|---|---|---|
| | permeability of | Capacity of | Art. Turf |
| | Basis (m/s) | Basis (g/cm³) | (degree Celsius) |
| Com. 1 | 0 | 0.07 | 70 |
| Emb. 1 | 5.0 × 10⁻⁴ | 0.21 | 59 |
| Emb. 2 | 4.6 × 10⁻⁴ | 0.21 | 57 |
| Emb. 3 | 3.1 × 10⁻⁴ | 0.20 | 57 |

### DESCRIPTION OF SYMBOLS

2 ground structure
4 concrete block
5 gap
6 basis
10 artificial turf
12 base sheet
14 pile
15 adhesive layer
16 drain hole
18 texture sand
20 ground
24 concrete block

What is claimed is:

1. A ground structure comprising a basis comprising arranged concrete blocks and an artificial turf fixed to the basis,
wherein the concrete blocks contain cement, sand, and an inorganic water retaining material, and have a water permeability of not less than 1.0×10⁻⁴ m/s and not more than 10.0×10⁻⁴ m/s and a water retention capacity of not less than 0.10 g/cm³ and not more than 0.40 g/cm³, both measured in accordance with JIS A 5371, and
wherein the artificial turf comprises a base sheet made of synthetic resin having drain holes and a synthetic resin pile fixed to the base sheet.

2. The ground structure of claim 1, wherein the concrete blocks have a water permeability of not less than 2.0×10⁻⁴ m/s and not more than 7.0×10⁻⁴ m/s and a water retention capacity of not less than 0.15 g/cm³ and not more than 0.30 g/cm³ or less.

3. The ground structure of claim 2, wherein the inorganic water retaining material comprises at least one of ceramic solidified material which is a sintered sludge and a granulated blast furnace slag produced by water-granulating high-temperature slag from a metal refining furnace as a by-product.

4. The ground structure of claim 2, wherein the concrete blocks contain cement of not less than 350 kg and not more than 450 kg, sand of not less than 600 kg and not more than 1500 kg, the inorganic water retaining material of not less than 500 kg and not more than 1500 kg, and coarse aggregate of at least 0 kg and not more than 200 kg, in each volume of 1 m³ of the concrete blocks.

5. A method for constructing a ground structure comprising a basis comprising arranged concrete blocks and an artificial turf fixed to the basis, the method comprising:
a step for producing the concrete blocks comprising:
preparing a mixture of cement, sand, an inorganic water retaining material, and water;
molding the mixture in a mold having a shape of the concrete block; and
curing the molded mixture;
such that the produced concrete blocks have a water permeability of not less than 1.0×10⁻⁴ m/s and not more than 10.0×10⁻⁴ m/s and a water retention capacity of not less than 0.10 g/cm³ and not more than 0.40 g/cm³, both measured in accordance with JIS A 5371;
a step for arranging the produced concrete blocks in a matrix on ground;
a step for fixing an artificial turf comprising a base sheet of synthetic resin having drain hoes and a pile of synthetic resin fixed to the base sheet on the arranged concrete blocks; and
a step for sprinkling texture sand on the artificial turf.
